(19) United States
(12) Patent Application Publication
(10) Pub. No.: US 2010/0101502 A1
(43) Pub. Date: Apr. 29, 2010

(54) Revolving bird feeding assembly

(76) Inventor: Leon Yang, Brooklyn, NY (US)

Correspondence Address: JACOBSON HOLMAN PLLC, 400 SEVENTH STREET N.W., SUITE 600, WASHINGTON, DC, 20004, US

(21) Appl. No.: 12/289,265

(22) Filed: Oct. 23, 2008

(51) Int. Cl. A01K 39/01

(52) U.S. Cl. 119/464

(57) ABSTRACT

A revolving bird feeding assembly where bird food in a birdcage can be changed or added to without intrusion into the birdcage. This object is accomplished by the use of a bird feed cup mounted in a receptacle which is rotatably mounted in an opening of a side panel of the birdcage. The receptacle supports the bird feeding cup in the birdcage. When it is time to either change the bird food or add additional bird food to the bird feeding cup, a slide bolt is moved into a retracted position. In this position, the receptacle is allowed to rotate 180° so that the bird feeding cup is moved from a position inside of the birdcage to a position outside of the birdcage.

### FIELD OF THE INVENTION

The present invention relates to a revolving bird feeding cup located in a receptacle rotatably mounted on a side panel of a birdcage.

### BACKGROUND OF THE INVENTION

A problem often encountered by bird owners is the refilling of a bird feed cup in a birdcage. The owner must open a side panel gate in the birdcage and reach their hand into the cage to retrieve a bird feed cup. While the hand and arm are inside of the cage, the hand and arm of the owner are subject to attack by the caged bird. This is also a stressful time for the bird by having their environment invaded by a human.

Therefore, there is a need to avoid the trauma to the bird owner as well as to the bird during bird feeding.

### SUMMARY OF THE INVENTION

Accordingly, it is an object of the present invention to provide a revolving bird feeding assembly where bird food in a birdcage can be changed or added to without intrusion into the birdcage.

This object is accomplished by the use of a bird feed cup mounted in a receptacle which is rotatably mounted in an opening of a side panel of the birdcage. The receptacle supports the bird feeding cup in the birdcage.

When it is time to either change the bird food or add additional bird food to the bird feeding cup, a slide bolt is moved into a retracted position. In this position, the receptacle is allowed to rotate 180° so that the bird feeding cup is moved from a position inside of the birdcage to a position outside of the birdcage. The bird feeding cup is then removable from the receptacle for either dumping of old bird food and refilling of the cup or adding additional bird food to the contents of the cup.

During the rotation of the receptacle, a portion of the receptacle blocks the opening in the side panel of the birdcage through which the receptacle rotates so as to prevent escape of the bird from the birdcage and prevents the possibility of attack of the owner by the bird. When the bird feeding cup is appropriately filled with bird food, the bird feeding cup is placed back into the receptacle and the receptacle is rotated through 180° to move the bird feeding cup from the exterior of the birdcage to the interior of the birdcage.

The slide bolt is then moved into an extended position to lock a tab or stop on one side of the receptacle between a side wall of an opening in the panel of the birdcage and the slide bolt. The receptacle is thereby prevented from rotation and the bird feeding cup is maintained in position inside the birdcage.

Accordingly, it is another object of the present invention to locate a revolving bird feeding receptacle in an opening in a side panel of a birdcage for movement of a portion of the receptacle from an interior of the birdcage to an exterior of the birdcage and subsequent return movement to the interior of the birdcage.

It is another object of the present invention to locate a revolving bird feeding receptacle in an opening in a side panel of a birdcage for movement of a portion of the receptacle from an interior of the birdcage to an exterior of the birdcage and subsequent return movement to the interior of the birdcage with the receptacle holding a cup for containing bird food which is removably mounted in the receptacle.

It is still yet another object of the present invention to locate a revolving bird feeding receptacle in an opening in a side panel of a birdcage for movement of a portion of the receptacle from an interior of the birdcage to an exterior of the birdcage and subsequent return movement to the interior of the birdcage with the receptacle including a stop for limiting rotation of the receptacle to approximately 180°.

It is still yet another object of the present invention to locate a revolving bird feeding receptacle in an opening in a side panel of a birdcage for movement of a portion of the receptacle from an interior of the birdcage to an exterior of the birdcage and subsequent return movement to the interior of the birdcage with the receptacle including a stop for limiting rotation of the receptacle to approximately 180° and the stop being engaged by side walls located on opposite sides of the opening in the side panel and locked in position on one of the side walls by a slidable bolt.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the revolving bird feeding assembly disclosed herein, and are for illustrative purposes only. Other embodiments that are substantially similar can use other components that have a different appearance.

FIG. 1 is a front perspective view of the bird feeding cup receptacle of the present invention.

FIG. 2 is a rear perspective view of the receptacle.

FIG. 3 is an exploded view of the receptacle being moved towards an opening in a side panel of a birdcage.

FIG. 4 is an exploded view of the mounting of the receptacle in the side panel of the birdcage.

FIG. 5 illustrates the positioning of the receptacle in the side panel of the birdcage for removing a bird feeding cup from a circular retention band.

FIG. 6 illustrates the partial movement of the receptacle for positioning of the bird feeding cup on the interior of the birdcage.

FIG. 7 illustrates the locking of the receptacle with the bird feeding cup located in the interior of the birdcage and a stop of the receptacle locked between a side wall of the opening in the side panel and a sliding bolt.

FIG. 8 is a sectional view taken along line 8-8 of FIG. 7.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

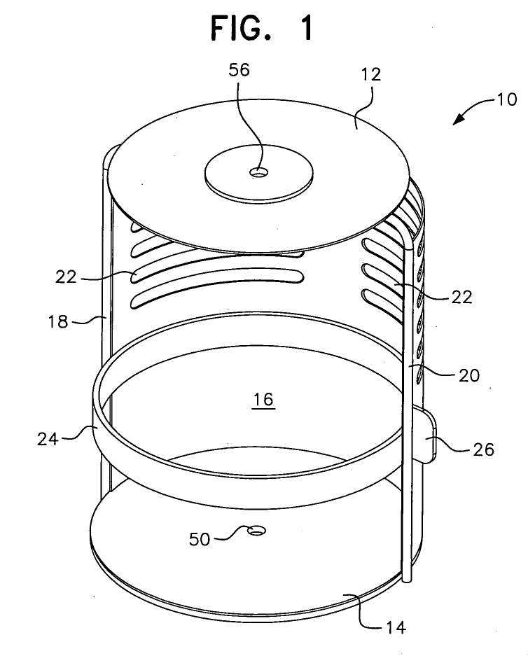

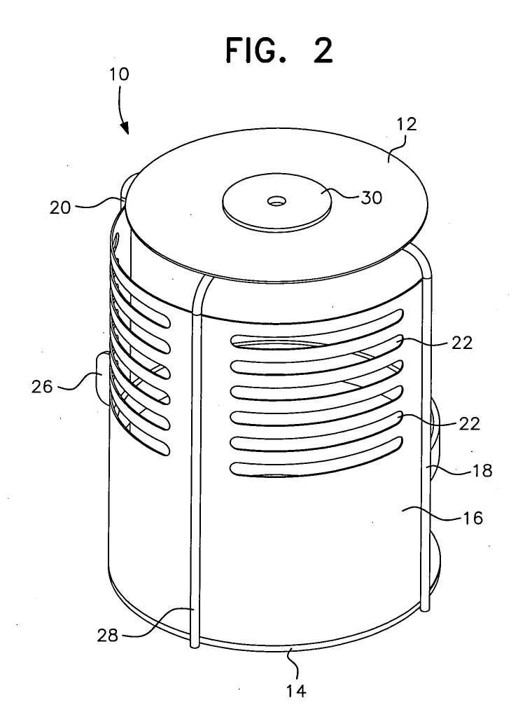

With reference to the drawings, in general, to FIGS. 1 and 2 in particular, a bird feeding receptacle embodying the teachings of the subject invention is generally designated as 10. With reference to its orientation in FIG. 1, the bird feeding receptacle includes a top disk 12 and a bottom disk 14. Extending between the disks 12 and 14 is a rear panel 16 having opposed vertical edge posts 18 and 20.

In the rear panel, are located a plurality of slots 22 in an upper portion of the panel to visualize the interior of the birdcage as will be explained with reference to additional figures. A horizontally extending circular band 24 is secured to the rear panel 16 for approximately half of its length with the other half of its length projecting forwardly of the rear panel 16 between edge posts 18 and 20. A vertically extending and horizontally projecting tab or stop 26 extends from only edge post 20 of the rear panel 16.

With reference to FIG. 2, the rear panel 16 is shown secured between three vertically extending posts with two of the posts forming the opposed edge posts 18, 20 of the rear panel. Centrally extending post 28 extends between the bottom disk 14 and the top disk 12. As shown in FIG. 2, the top portions of posts 18, 20 and 28, curve inwardly to connect with the upper disk 12. Centrally located on upper disk 12 is a reduced friction plate 30 which assists in the rotation of the receptacle.

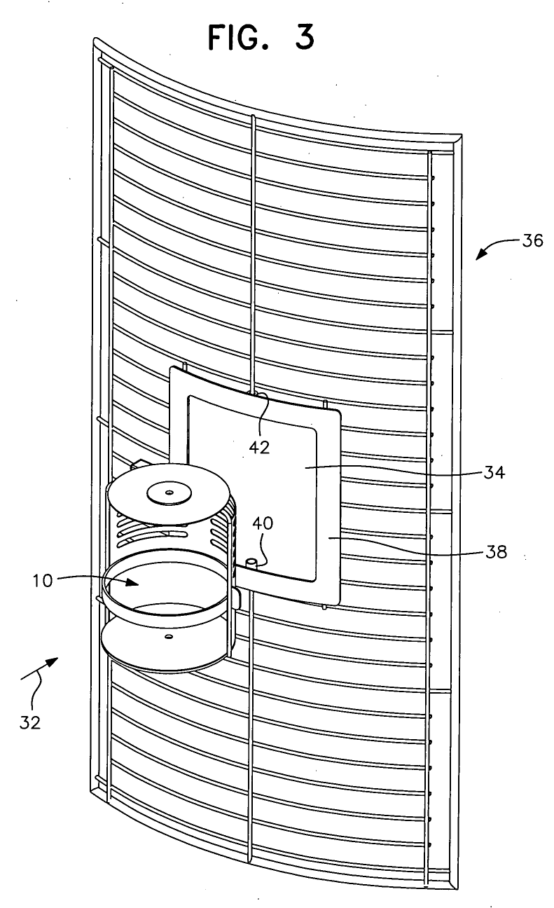

As shown with reference to FIG. 3, the receptacle 10 is moved in the direction of arrow 32 for securing in an opening 34 of a side panel 36 of a birdcage. The opening 34 is defined by a square frame 38 which includes a pivot sleeve 40 for use in conjunction with the receptacle 10. A sleeve 42 is located at the upper portion of the frame 38. It is understood as being part of the present invention that the side panel 36 may be of arcuate or flat configuration, and it only being necessary that the frame 38 is located in a vertical portion of a birdcage to accommodate the rotation of the receptacle 10 within an opening defined by the frame 38.

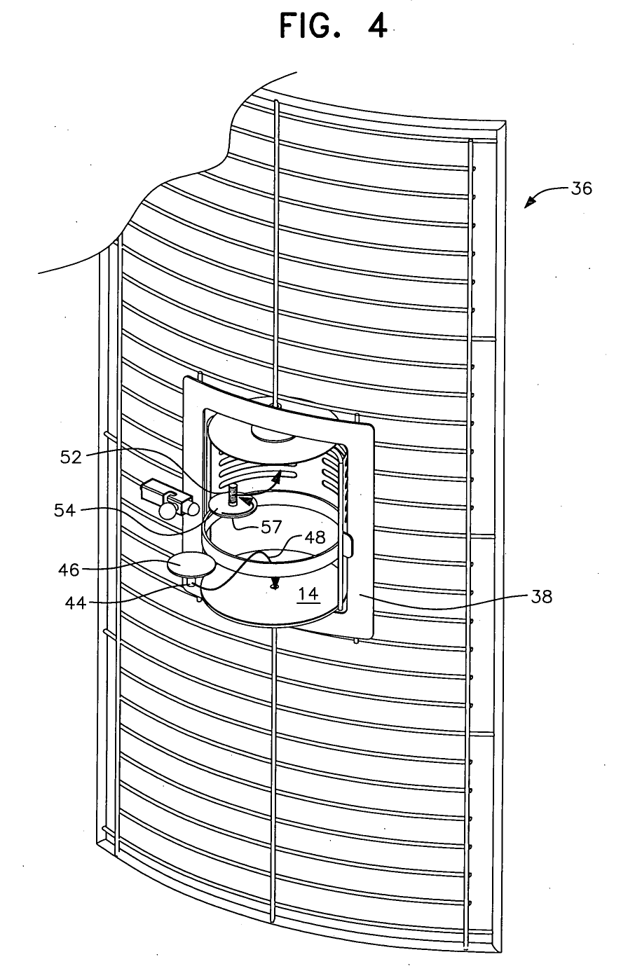

In FIG. 4, the receptacle 10 is located in the opening 34 defined by the frame 38 in the side panel 36. A pivot pin 44 secured to the underside of a pivot plate 46 is positioned in the direction of arrow 48 so that the pin 44 passes through an opening 50 in disk 14 and passes into sleeve 40. Similarly, at the upper end of the receptacle 10, a threaded pin 52 extending vertically from a pivot plate 54 is passed through an opening 56 in the disk 12 and reduced friction plate 30 for anchoring in sleeve 42. Arrow 57 shows the direction of rotation of the plate 54 for securing the pin 52 in sleeve 42.

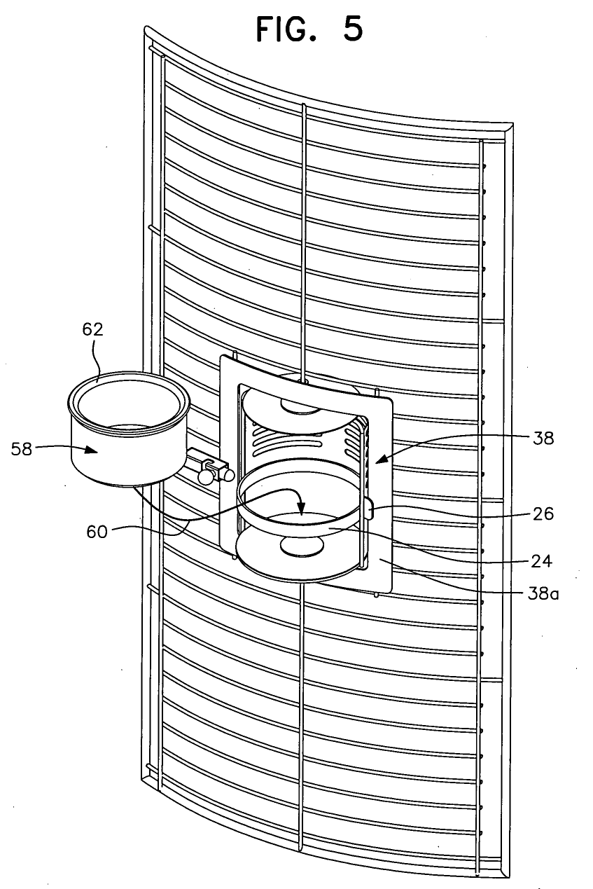

As shown in FIG. 5, the receptacle is positioned in the frame 38 so that access is provided to the interior of the receptacle 10 from the exterior of a birdcage. In this position, a bird feeding cup 58 may be filled with bird food and placed in the receptacle 10 in the direction of arrow 60 such that the cup 58 sits on disk 14 and plate 46. The rim 62 of the cup 58 is located adjacent to band 24. The receptacle 10 is held in the position shown in FIG. 5 by the engagement of the tab or stop 26 with a vertical side wall 38a of the frame 38.

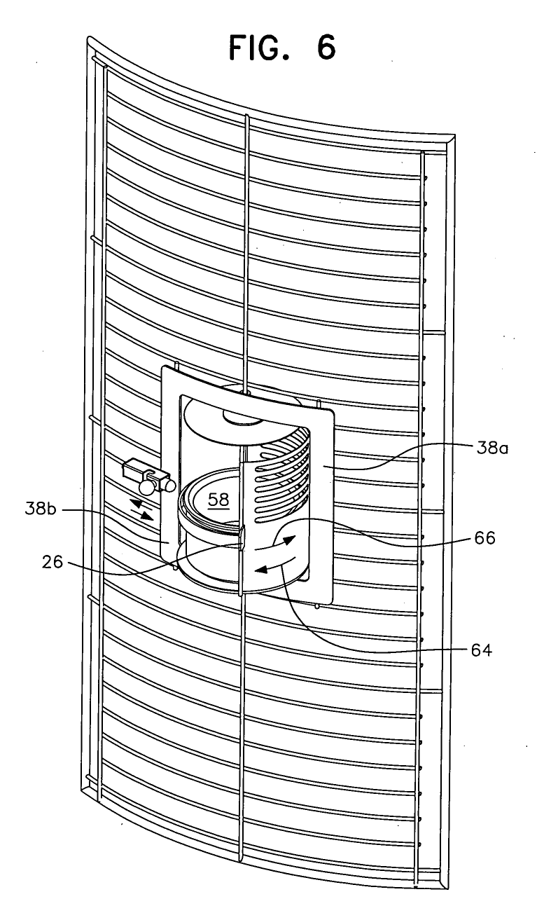

In FIG. 6, the receptacle is rotated in the direction of arrow 64 so that the stop 26 is moved away from the side wall 38a in a direction of opposite side wall 38b of the frame 38. During this rotation, the bird feeding cup 58 is moved into the interior of the birdcage.

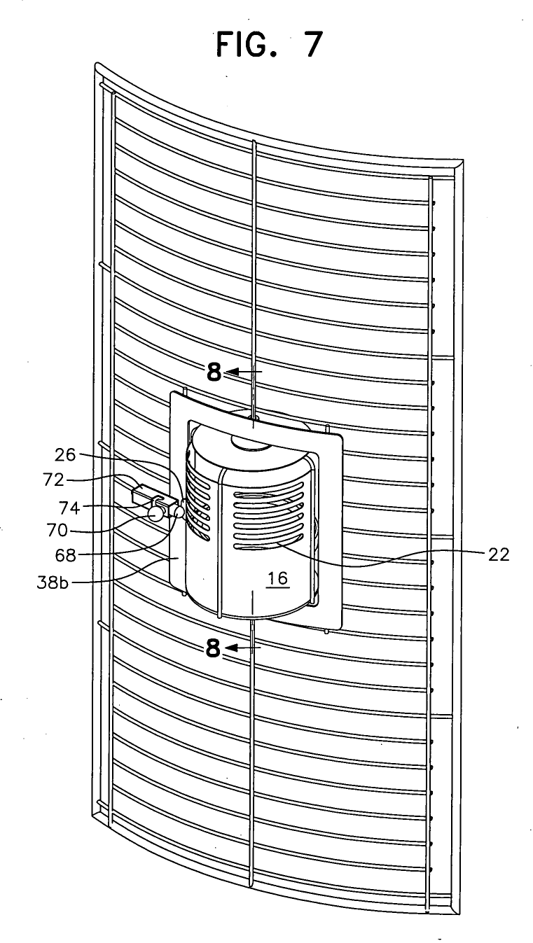

When the receptacle 10 is rotated so that the exposed portion of the bird feeding cup is located entirely outside of the birdcage, by rotation of the receptacle in the direction of arrow 66, the receptacle 10 will be positioned with the exposed portion of the bird feeding cup facing the exterior of the birdcage in a position as shown in FIG. 5. When the receptacle 10 is moved by rotation in the direction of arrow 64, to the position shown in FIG. 7, a locking bolt 68 is moved by handle 70 to slide rearwardly within a channel 72 so as to allow the tab or stop 26 to engage side wall 38b of frame 38. When the tab or stop 26 engages the side wall 38b, the bolt is slid forward by moving the handle within keyway 74 to the position shown in FIG. 7. The tab 26 is thereby locked between the side wall 38b of the frame 38 and the bolt 68.

In this position, the receptacle 10 is located with the exposed portion of the bird feeding cup located in the interior of the birdcage. A bird or birds located in the birdcage now have full access to the contents of the bird feeding cup. The level of bird food in the cup is visible through the slots 22 in the rear panel 16 of the receptacle 10.

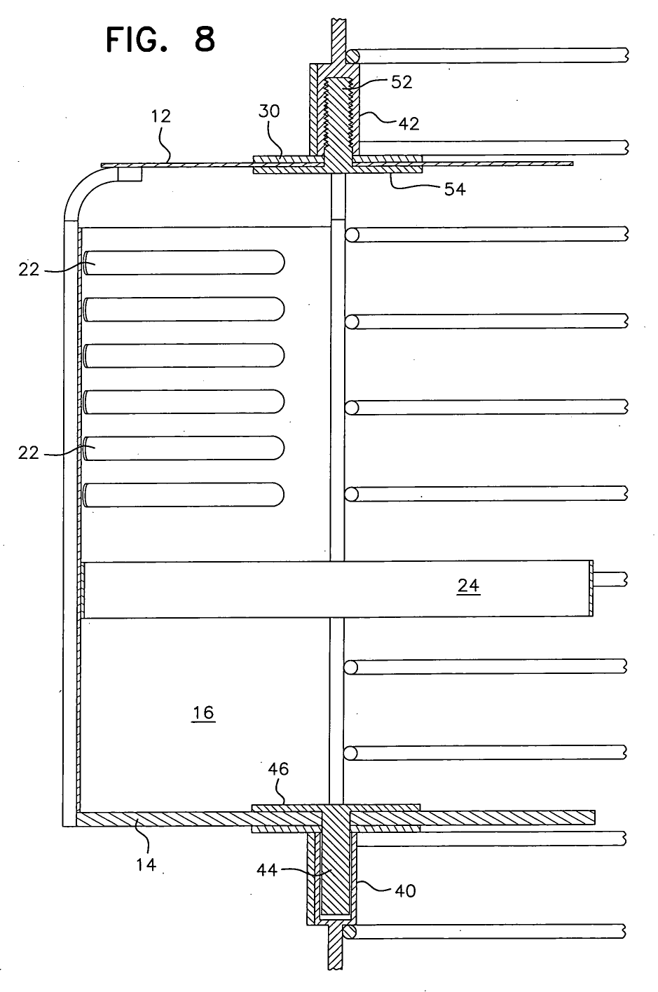

As shown in the cross-sectional view of FIG. 8, the rotation of the receptacle 10 is allowed by the rotation of disk 12 between fixed plate 54 and reduced friction plate 30 at the upper end of the receptacle 10. At the lower end of the receptacle 10, rotation of the disk 14 and plate 46 is achieved by pin 44 rotatably mounted in sleeve 40.

By the present invention, a bird feeding cup is movable from an interior of a birdcage to the exterior of the birdcage for replacement of the bird food and subsequent rotation back into the interior of the birdcage. Therefore, from the exterior of a birdcage, bird food may be replaced without exposing the arm of the owner to the interior and thus to the bird located in the interior of the birdcage. This provides an improved quality of life for the bird and protection for the bird owner.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A revolving bird feeding assembly comprising
a side panel of a birdcage,
an opening located in said panel, and
a receptacle rotatably mounted on said side panel in said opening for movement of a portion of the receptacle from an interior of the birdcage to an exterior of the birdcage and return movement to the interior of the birdcage.

2. The revolving bird feeding assembly of claim 1, wherein said receptacle holds a cup for bird feed.

3. The revolving bird feeding assembly of claim 1, wherein said receptacle includes a stop for limiting rotation of said receptacle to approximately 180°.

4. The revolving bird feeding assembly of claim 3, wherein said stop is engaged by sidewalls located on opposite sides of said opening.

5. The revolving bird feeding assembly of claim 4, wherein said stop is located in a locked position against one of the sidewalls.

6. The revolving bird feeding assembly of claim 5, wherein said one sidewall includes a slidable bolt.

7. The revolving bird feeding assembly of claim 6, wherein said stop is locked in place between said one sidewall and said bolt when said bolt is in an extended position and said stop is movable towards the other of the sidewalls when said bolt is in a retracted position.

8. The revolving bird feeding assembly of claim 2, wherein approximately one half of the receptacle includes a cup holding portion in a form of a band for receipt of the cup.

9. The revolving bird feeding assembly of claim 6, wherein said slidable bolt includes a handle slidable in a keyway of a housing.

10. The revolving bird feeding assembly of claim 1, wherein said receptacle is rotatably mounted on said side panel about pins extending upwardly and downwardly from said receptacle into sleeves of said side panel.

11. A revolving bird feeding assembly comprising
a side panel of a birdcage,
an opening located in said panel, and
a receptacle rotatably mounted on said side panel in said opening for movement of a portion of the receptacle from an interior of the birdcage to an exterior of the birdcage and return movement to the interior of the birdcage,
said receptacle including a semi-circular rear wall and a semi-circular front band extending between opposite side edges of said rear wall.

12. The revolving bird feeding assembly of claim 11, wherein said receptacle holds a cup for bird feed.

13. The revolving bird feeding assembly of claim 11, wherein said receptacle includes a stop for limiting rotation of said receptacle to approximately 180°.

14. The revolving bird feeding assembly of claim 13, wherein said stop is engaged by sidewalls located on opposite sides of said opening.

15. The revolving bird feeding assembly of claim 14, wherein said stop is located in a locked position against one of the sidewalls.

16. The revolving bird feeding assembly of claim 15, wherein said one sidewall includes a slidable bolt.

17. The revolving bird feeding assembly of claim 16, wherein said stop is locked in place between said one sidewall and said bolt when said bolt is in an extended position and said stop is movable towards the other of the sidewalls when said bolt is in a retracted position.

18. The revolving bird feeding assembly of claim 12, wherein approximately one half of the receptacle includes a cup holding portion in a form of the band for receipt of the cup.

19. The revolving bird feeding assembly of claim 16, wherein said slidable bolt includes a handle slidable in a keyway of a housing.

20. The revolving bird feeding assembly of claim 11, wherein said receptacle is rotatably mounted on said side panel about pins extending upwardly and downwardly from said receptacle into sleeves of said side panel.
